(19) United States
(12) Patent Application Publication
(10) Pub. No.: US 2022/0368087 A1
(43) Pub. Date: Nov. 17, 2022

(54) CABLE CONNECTOR AND CABLE CONNECTOR ASSEMBLY

(71) Applicant: Yamaichi Electronics Co., Ltd., Tokyo (JP)

(72) Inventors: Kiyoshi ABE, Tokyo (JP); Takahiro SHIMOYAMA, Tokyo (JP)

(73) Assignee: Yamaichi Electronics Co., Ltd., Tokyo (JP)

(21) Appl. No.: 17/765,719

(22) PCT Filed: Oct. 3, 2019
(86) PCT No.: PCT/JP2019/039122

§ 371 Date: Mar. 31, 2022

(51) Int. Cl. H01R 13/6591; H01R 13/42; H01R 13/6585

(52) U.S. Cl. CPC H01R 13/65915; H01R 13/42; H01R 13/6585

(57) ABSTRACT

Provided are a cable connector and a cable connector assembly that can reduce crosstalk that may occur between proximate differential pairs at an end of a cable on an electronic device side. The cable connector for electrically connecting a cable (31a) to an electronic device (for example, an optical transceiver or an integrated circuit) includes a metal shield member (20) configured to cover a circumference of a part near an end of a differential pair (30a) on the electronic device side, and the differential pair is formed of the cable (31a).

### TECHNICAL FIELD

The present invention relates to a cable connector and a cable connector assembly.

### BACKGROUND ART

A jumper cable may be used for a connection between an optical transceiver and an application specific integrated circuit (ASIC) so that high speed transmission can be implemented, for example.

A jumper cable is connected to an electronic device such as an optical transceiver, an ASIC, or the like via a high speed transmission connector. An example of such a high speed transmission connector may be that disclosed in Patent Literature 1, for example.

### CITATION LIST

### Patent Literature

[PTL 1]
U.S. Patent Application Publication No. 2016/0218455

### SUMMARY OF INVENTION

### Technical Problem

In differential high speed transmission, it is required to suppress crosstalk that would be ignored in typical differential transmission. Thus, further reduction of crosstalk is required in differential high speed transmission. The high speed transmission connector disclosed in Patent Literature 1 does not have a shield layer of a cable in a wire connection portion between the end of the cable and a terminal of the connector, and crosstalk may occur between proximate (adjacent) differential pairs.

Accordingly, the present invention intends to provide a cable connector and a cable connector assembly that can reduce crosstalk that may occur between proximate differential pairs at an end of a cable on an electronic device side.

### Solution to Problem

To solve the above problem, the cable connector and the cable connector assembly of the present invention employ the following solutions.

That is, a cable connector according to one aspect of the present invention is a cable connector for electrically connecting one or more cables to an electronic device. The cable connector includes a metal shield member configured to cover a circumference of a part near an end of the differential pair on the electronic device side, and the differential pair is formed of the one or more cables.

According to the cable connector of the present aspect, it is possible to cover a part near the end of a differential pair on the electronic device side with a metal shield member.

Since a terminal (a signal terminal, a ground terminal) is connected to an end of the cable on the electronic device side, no shield layer of the cable is present at the end. Thus, crosstalk may occur between proximate differential pairs. However, by providing a shield member covering a part near the end of the differential pair on the electronic device side, it is possible to reduce crosstalk that may occur between the proximate differential pairs.

Note that the expression “cover” as used herein means surrounding a differential pair when viewed from an extension direction of a cable, which is to surround the upper and under sides and the left and right sides of the differential pair, for example.

Further, in the cable connector according to one aspect of the present invention, the shield member has a first shield member configured to cover one side of the circumference of the differential pair and a second shield member configured to cover all the other sides of the circumference of the differential pair.

According to the cable connector of the present aspect, by installing the differential pair to the second shield member from opened one side of the second shield member (the side covered with the first shield member) and then covering the opened one side with the first shield member, it is possible to easily configure a form in which the circumference of the differential pair is covered. Alternatively, by installing the differential pair on the first shield member and then covering the differential pair with the second shield member from the opened one side thereof, it is possible to easily configure a form in which the differential pair is covered.

Further, in the cable connector according to one aspect of the present invention, a plurality of second shield members are arranged in parallel in a predetermined direction, and the first shield member is integrally formed in the parallel direction with respect to the plurality of second shield members.

According to the cable connector of the present aspect, since the first shield member is integrally formed with respect to the plurality of second shield members in the parallel direction thereof, it is possible to cover an open face of the plurality of second shield members with a single first shield member at once. This can improve ease of assembly.

Further, the cable connector according to one aspect of the present invention is a cable connector for electrically connecting a cable to an electronic device. The cable connector includes a metal shield member configured to cover an upper side and/or an underside of a part near an end of each of a plurality of differential pairs formed of the one or more cables and arranged in parallel at a predetermined interval in a predetermined direction, and the end is on the electronic device side. A dimension of the predetermined interval is greater than or equal to a dimension of each of the differential pairs in the predetermined direction.

Since a terminal (a signal terminal, a ground terminal) is connected to an end of the cable on the electronic device side, no shield layer of the cable is present at the end. Thus, crosstalk may occur between one plurality of differential pairs arranged in parallel in a predetermined direction (for example, horizontal direction) and another plurality of differential pairs in close proximity to the one plurality of differential pairs in the upward direction or the downward direction. However, by providing a shield member that covers the upper side and the underside near the end of each of the plurality of differential pairs on the electronic device side, it is possible to reduce crosstalk that may occur between differential pairs in close proximity to each other in the upward direction or the downward direction.

Note that the plurality of differential pairs arranged in parallel in the predetermined direction are arranged at a predetermined interval. In such a case, by designing the cable connector such that the dimension of the predetermined interval is greater than or equal to the dimension of the differential pair in the predetermined direction (the parallel direction of the differential pairs), the differential pairs arranged in parallel in the predetermined direction can be spaced apart from each other. The differential pairs are spaced apart from each other, and thereby crosstalk between the differential pairs in the predetermined direction can be reduced without a shield member.

Further, the cable connector according to one aspect of the present invention includes the shield member configured to cover another set of the plurality of differential pairs stacked above and/or below the plurality of differential pairs.

According to the cable connector of the present aspect, one plurality of differential pairs are stacked above or below another plurality of differential pairs. That is, one plurality of differential pairs arranged in parallel in a predetermined direction and another plurality of differential pairs arranged in parallel in the predetermined direction are stacked in the vertical direction in multiple layers.

Further, in the cable connector according to one aspect of the present invention, the shield member covers the differential pairs each formed of two cables.

According to the cable connector of the present aspect, the shield member can be used to cover a differential pair formed of two cables (for example, a two coaxial cables).

Further, in the cable connector according to one aspect of the present invention, the shield member covers the differential pairs each formed of one cable.

According to the cable connector of the present aspect, the shield member can be used to cover a differential pair formed of a single cable (for example, a twinax cable).

Further, a cable connector assembly according to one aspect of the present invention has the cable connector described above and the one or more cables.

### Advantageous Effects of Invention

According to the present invention, it is possible to provide a cable connector and a cable connector assembly that can reduce crosstalk that may occur between proximate differential pairs at an end of a cable on an electronic device side.

### BRIEF DESCRIPTION OF DRAWINGS

FIG. 1 is a perspective view illustrating a cable connector assembly according a first embodiment of the present invention.

FIG. 2 is a perspective view illustrating a state where the cable connector assembly illustrated in FIG. 1 has been attached to a cage.

FIG. 3 is a perspective view illustrating an exploded diagram of a shield member according to the first embodiment of the present invention.

FIG. 4 is a perspective view illustrating an assembly diagram of the shield member according to the first embodiment of the present invention.

FIG. 5 is a perspective view illustrating an exploded diagram of the shield member according to the first embodiment of the present invention (when a twinax cable is used).

FIG. 6 is a perspective view illustrating a cable connector assembly and an SMT connector according to a second embodiment of the present invention.

FIG. 7 is a perspective view illustrating a state where the cable connector assembly and the SMT connector according to the second embodiment of the present invention are being connected to each other.

FIG. 8 is a perspective view illustrating a state where the cable connector assembly and the SMT connector according to the second embodiment of the present invention have been connected to each other.

FIG. 9 is a perspective view illustrating an exploded diagram of a cable connector according to the second embodiment of the present invention.

FIG. 10 is a perspective view illustrating an exploded diagram of a shield member according to the second embodiment of the present invention.

FIG. 11 is a perspective view illustrating an assembly diagram of the shield member according to the second embodiment of the present invention.

FIG. 12 is a perspective view illustrating an assembly diagram of the shield member according to the second embodiment of the present invention (when a twinax cable is used).

FIG. 13 is a perspective view illustrating a cable connector assembly according to a third embodiment of the present invention.

FIG. 14 is a perspective view illustrating an exploded diagram of a cable connector according to the third embodiment of the present invention.

FIG. 15 is a perspective view illustrating an exploded diagram of the cable connector according to the third embodiment of the present invention.

FIG. 16 is a perspective view illustrating an exploded diagram of a shield member according to the third embodiment of the present invention.

FIG. 17 is a perspective view illustrating an exploded diagram of the cable connector according to the third embodiment of the present invention.

FIG. 18 is a perspective view illustrating an exploded diagram of the cable connector according to the third embodiment of the present invention (when a twinax cable is used).

### DESCRIPTION OF EMBODIMENTS

The cable connector according to the present invention is a component for electrically connecting an electronic device such as an optical transceiver, an SMT connector (surface mount connector), an integrated circuit, or the like and a cable to each other, for example. Further, a cable connector assembly in which a cable connector and a cable are connected to each other is a component for electrically connecting the optical transceiver and the SMT connector described above (in particular, an integrated circuit such as an ASIC on which the SMT connector is mounted) to each other, for example.

### First Embodiment

The cable connector and the cable connector assembly according to a first embodiment of the present invention will be described below with reference to the drawings.

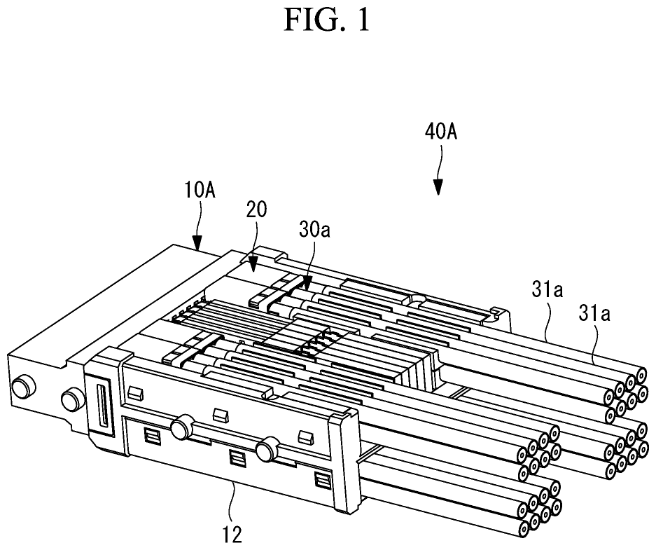

As illustrated in FIG. 1, a plurality of coaxial cables 31a and a cable connector 10A are connected to each other to form a cable connector assembly 40A.

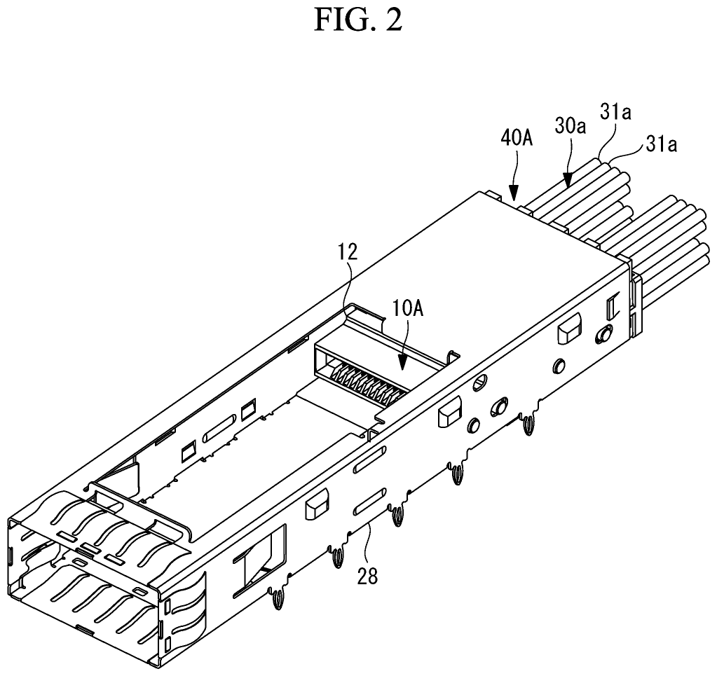

As illustrated in FIG. 2, the cable connector 10A is housed in a cage 28 having a rectangular cylindrical casing. An optical transceiver (not illustrated) is inserted in the cage 28 and is further plugged in the cable connector 10A, and thereby the optical transceiver and the coaxial cables 31a are electrically connected via the cable connector 10A. That is, the optical transceiver and the cable connector assembly 40A are electrically connected to each other.

As illustrated in FIG. 1, the cable connector 10A has a resin housing 12 and shield members 20 held in the resin housing 12. A plurality of coaxial cables 31a are drawn from the housing 12. In this state, two coaxial cables 31a form one set of a differential pair 30a.

Note that, for the housing 12 illustrated in FIG. 1, although a casing on the top face is not depicted for the sake of illustration, there also is a casing on the top face in the actual implementation.

Signal terminals (not illustrated) and ground terminals (not illustrated) held by the housing 12 are provided to portions located on the tip side of the coaxial cables 31a inside the housing 12. Further, one signal terminal and one ground terminal are connected to each one coaxial cable 31a.

The circumference of a part near the connection part of the coaxial cables 31a to the signal terminal and the ground terminal (a part near the end on the optical transceiver side) is covered with a metal shield member 20 for each differential pair 30a and configured to suppress crosstalk between the differential pairs 30a.

Note that the shield member 20 is a different member from braided wires 33 as a shield layer of the coaxial cable 31a.

The shield member 20 will be described below.

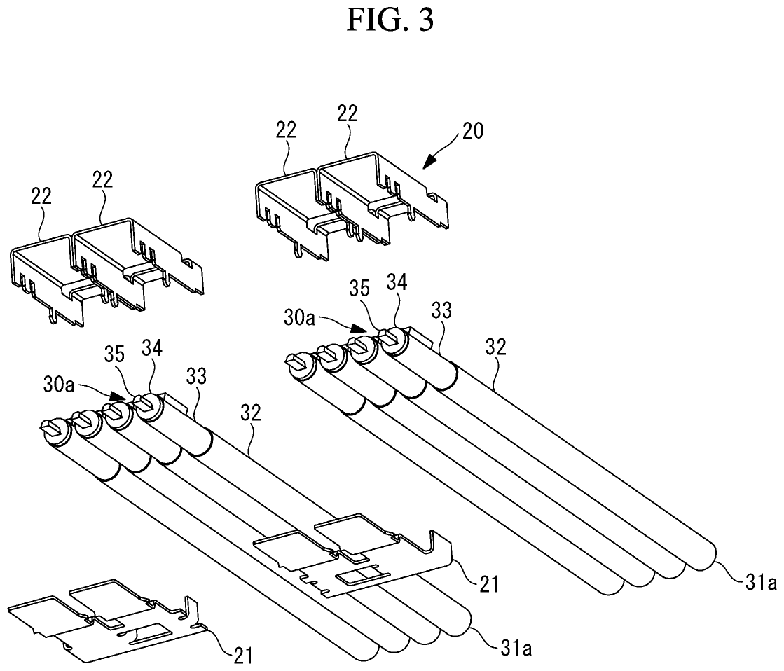

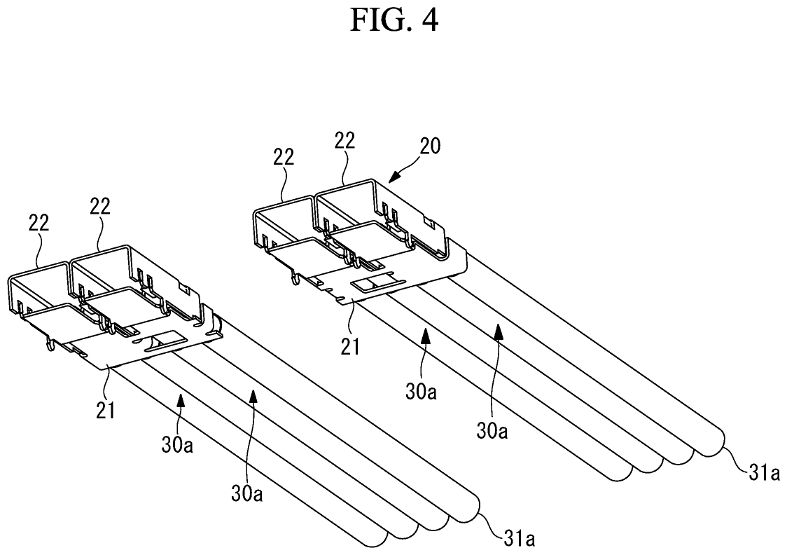

As illustrated in FIG. 3 and FIG. 4, the shield member 20 is a thin plate-like member covering the circumference of a part near the end of the coaxial cable 31a on the optical transceiver side.

Note that “covering” as used herein means surrounding the differential pair 30a when viewed from the extension direction of the coaxial cable 31a, for example, surrounding four sides including the upper and under sides and the left and right sides of the differential pair 30a.

As illustrated in FIG. 3, each coaxial cable 31a is formed of an outer sheath 32 covering the outer circumference, braided wires 33 covered with the outer sheath 32, an insulator 34 covered with the braided wires 33, and a conducting wire 35 passing through substantially the center of the insulator 34.

The coaxial cable 31a is in a state where the outer sheath 32 on the tip side is peeled off and the conducting wire 35 is exposed on the further tip side (at the tip).

While the braided wires 33 of the coaxial cable 31a function as a shield layer of the coaxial cable 31a, the braided wires 33 is absent at the tip where the conducting wire 35 is exposed. Thus, the shield member 20 instead of the braided wires 33 (shield layer) is provided at the portion to suppress crosstalk between the differential pairs 30a.

As illustrated in FIG. 3 and FIG. 4, the shield member 20 has metal underside shield members (first shield member) 21 and a metal U-shaped shield member (second shield member) 22.

Each U-shaped shield member 22 is a U-shaped thin plate whose one side is opened and installed for each differential pair 30a (two coaxial cables 31a). In the case of FIG. 3 and FIG. 4, the underside of the U-shaped shield member 22 is an open face, and the upper side and the left and right sides are closed.

As illustrated in FIG. 3, when the differential pair 30a is put into the U-shaped shield member 22 from the open face and housed inside, the U-shaped shield member 22 can cover the differential pair 30a from directions other than the direction of the open face of the U-shaped shield member 22, as illustrated in FIG. 4.

As illustrated in FIG. 3 and FIG. 4, a plurality of U-shaped shield members 22 are arranged in parallel in accordance with a parallel direction of the plurality of differential pairs 30a arranged in parallel in a predetermined direction. In the present embodiment, the number of differential pairs 30a and the number of U-shaped shield members 22 are the same.

The underside shield member 21 is a thin plate-like member attached from below the U-shaped shield members 22 so as to cover the open face of the U-shaped shield members 22.

One underside shield member 21 is provided for two U-shaped shield members 22. That is, the underside shield member 21 is integrally formed so as to cover the open faces of two U-shaped shield members 22 at once in the parallel direction of the two U-shaped shield members 22.

To summarize the above, one differential pair 30a is covered with one underside shield member 21 and one U-shaped shield member 22, and two differential pairs 30a are covered with one underside shield member 21 and two U-shaped shield members 22. Further, three sides including sides in the parallel direction of the differential pair 30a are covered with the U-shaped shield member 22, and the remaining one side is covered with the underside shield member 21. Accordingly, since proximate (adjacent) differential pairs 30a are separated from each other by the shield member 20, crosstalk that may occur between the proximate differential pairs 30a can be reduced.

Note that the U-shaped shield members 22 and the underside shield members 21 may be associated with each other in a one-to-one manner or may be associated with each other in a multiple (three or more)-to-one manner, and the combination thereof is not particularly limited. Further, two U-shaped shield members 22 may be integrally formed.

Further, although the differential pairs 30a are in close proximity in the lateral direction in FIG. 4, a layer formed of a plurality of differential pairs 30a arranged in parallel in the lateral direction may be stacked in multiple layers in the vertical direction. Also in such a case, crosstalk that may occur between the differential pairs 30a in close proximity (adjacent) in the vertical direction can be reduced by the shield member 20.

In the present embodiment, the following advantageous effects are achieved.

According to the cable connector 10A, a part near the end of the differential pair 30a on the optical module (not illustrated) side (a part near the portion where the conducting wire 35 is exposed) can be covered with the shield member 20. Accordingly, even when the braided wires 33 as a shield layer of the coaxial cable 31a is absent, crosstalk that may occur between proximate differential pairs 30a can be reduced by the shield member 20.

Further, the shield member 20 has the U-shaped shield members 22 and the underside shield member 21. Thus, by installing the differential pair 30a on the underside shield member 21 and then covering the differential pair 30a with the U-shaped shield member 22 from the opened one side thereof, it is possible to easily configure a form in which the circumference of the differential pair 30a is covered.

Further, since the underside shield member 21 is integrally formed in the parallel direction with respect to the plurality of U-shaped shield members 22, it is possible to cover the open faces of the plurality of U-shaped shield members 22 with the single underside shield member 21 at once. This can improve ease of assembly.

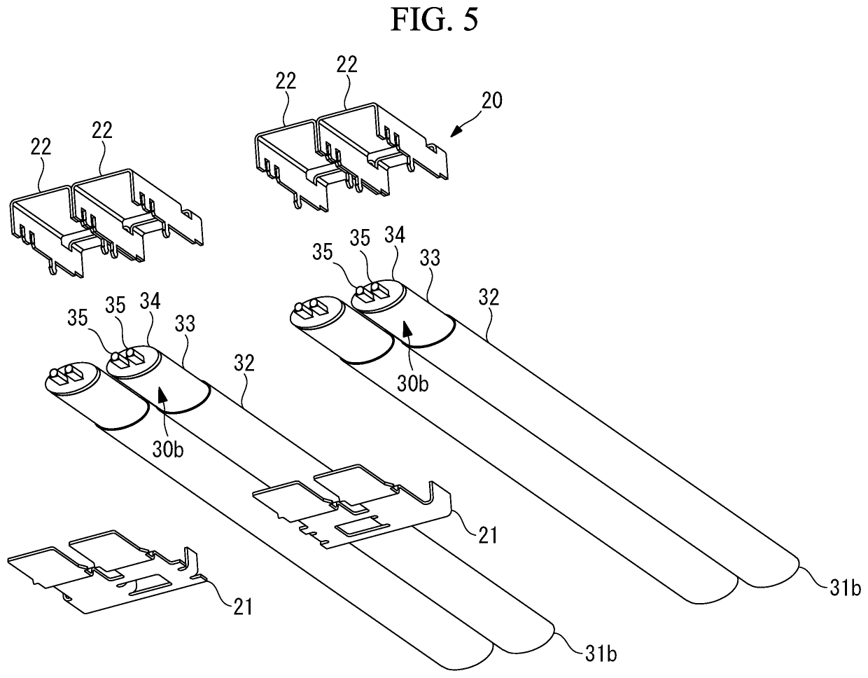

Note that, although the differential pair 30a is formed of two coaxial cables 31a in the above description, the differential pair 30b may be formed of a twinax cable (cable) 31b in which two conducting wires 35 run in one cable, as illustrated in FIG. 5.

In such a case, one twinax cable 31b will be covered with one underside shield member 21 and one U-shaped shield member 22, and two twinax cables 31b will be covered with one underside shield member 21 and two U-shaped shield members 22.

### Second Embodiment

The cable connector and the cable connector assembly according to a second embodiment of the present invention will be described below with reference to the drawings. Note that the present embodiment differs from the first embodiment in the form of the shield member or the connection position of the cable connector. Thus, in the following description, the same features as those in the first embodiment will be labeled with the same references to omit the description thereof, and different features will be described.

As illustrated in FIG. 6, a plurality of coaxial cables 31a and a cable connector 10B are connected to each other to form a cable connector assembly 40B.

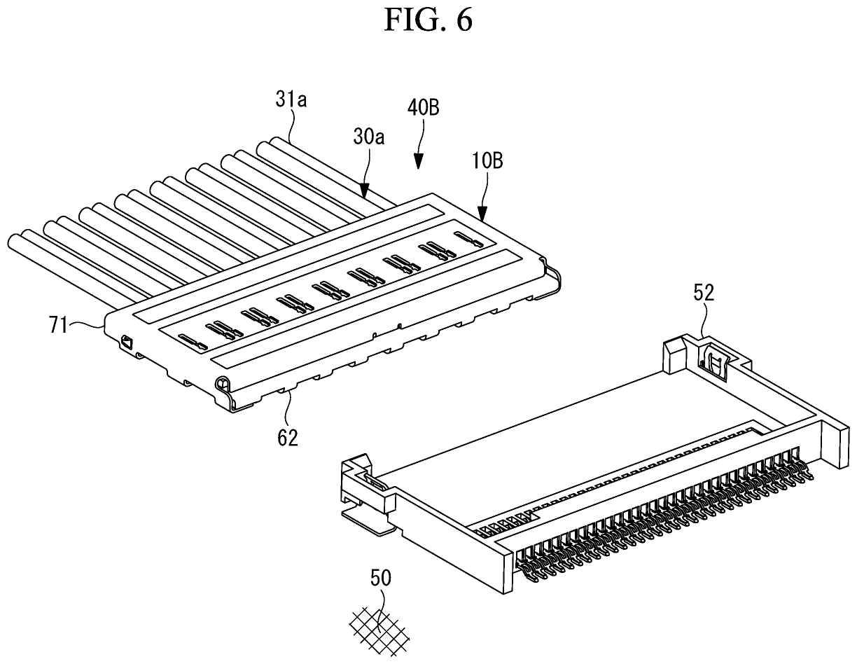

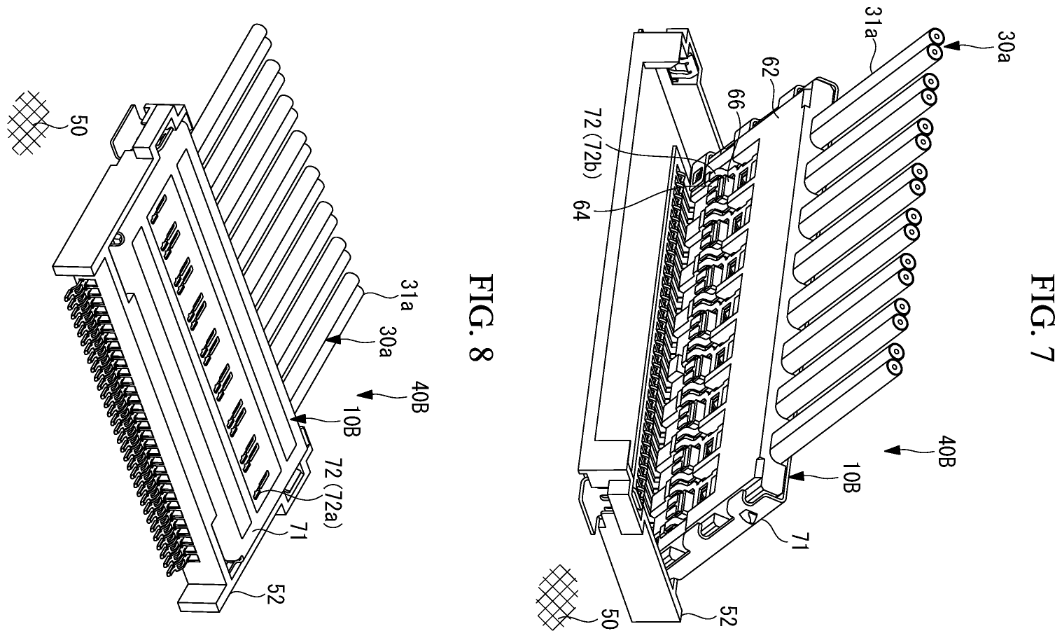

As illustrated in FIG. 7 and FIG. 8, the cable connector 10B is fit from above and connected to an SMT connector (electronic device) 52, which is mounted directly by soldering or the like on an integrated circuit 50 such as an ASIC. This causes the SMT connector 52 (integrated circuit 50) and the coaxial cables 31a to be electrically connected via the cable connector 10B. That is, the SMT connector 52 (integrated circuit 50) and the cable connector assembly 40B are electrically connected to each other.

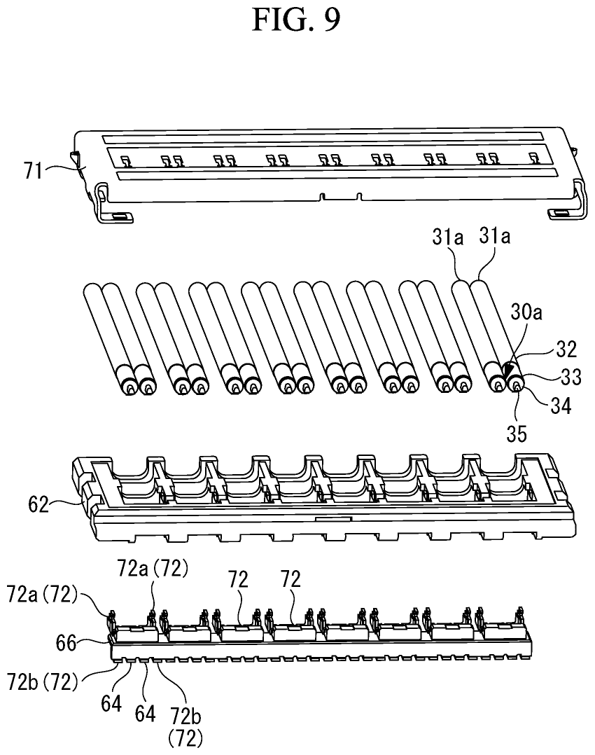

As illustrated in FIG. 9, the cable connector 10B has a resin housing 62, a resin terminal holding member 66 attached from below the housing 62, and a shell cover (first shield member) 71 attached from above the housing 62. Further, the cable connector 10B further has a plurality of signal terminals 64 and a plurality of shield terminals 72 held in the terminal holding member 66. A plurality of coaxial cables 31a are drawn from the housing 62. In this state, two coaxial cables 31a form one set of the differential pair 30a.

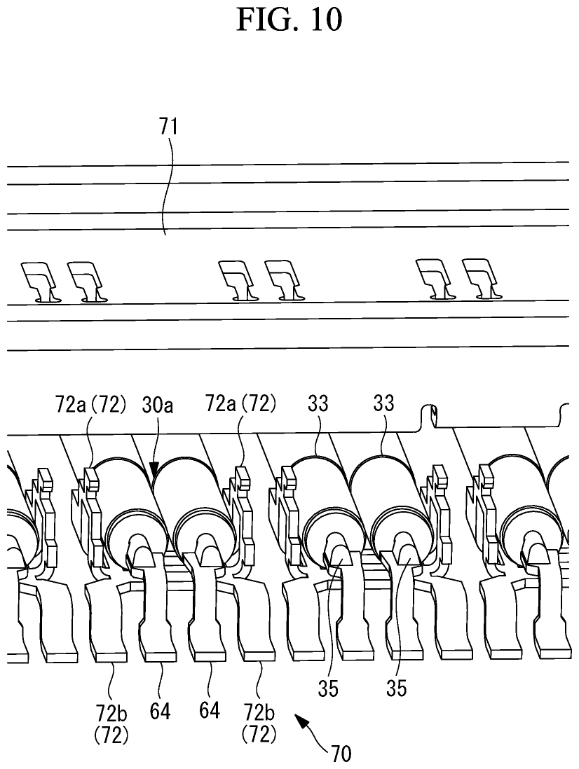

As illustrated in FIG. 10, the metal signal terminals 64 and the metal shield terminals 72 held in the terminal holding member 66 are arranged on the tip side of the coaxial cables 31a. Note that illustration of the housing 62 and the terminal holding member 66 is omitted in FIG. 10 for the sake of illustration.

Each signal terminal 64 is connected to the conducting wire 35 of the coaxial cable 31a in a one-to-one manner.

Each shield terminal 72 has a shield part (second shield member) 72a and a ground terminal part 72b and has at least two functions.

The first function is a function as a grounding terminal. The ground terminal part 72b integrally formed with the shield part 72a to be in contact with the coaxial cable 31a is electrically connected to the ground of the SMT connector 52. Accordingly, the ground terminal part 72b functions as a grounding terminal.

The second function is a function as a component of the shield member 70. The shield part 72a of the shield terminal 72 is a U-shaped thin plate whose one side is opened and installed for each differential pair 30a (two coaxial cables 31a). In the case of FIG. 10, the upper side of the shield part 72a is an open face, and the underside and the left and right sides are closed.

When the differential pair 30a is put into the shield part 72a from the open face and housed inside, the shield part 72a covers the differential pair 30a in directions other than the direction of the open face of the shield part 72a.

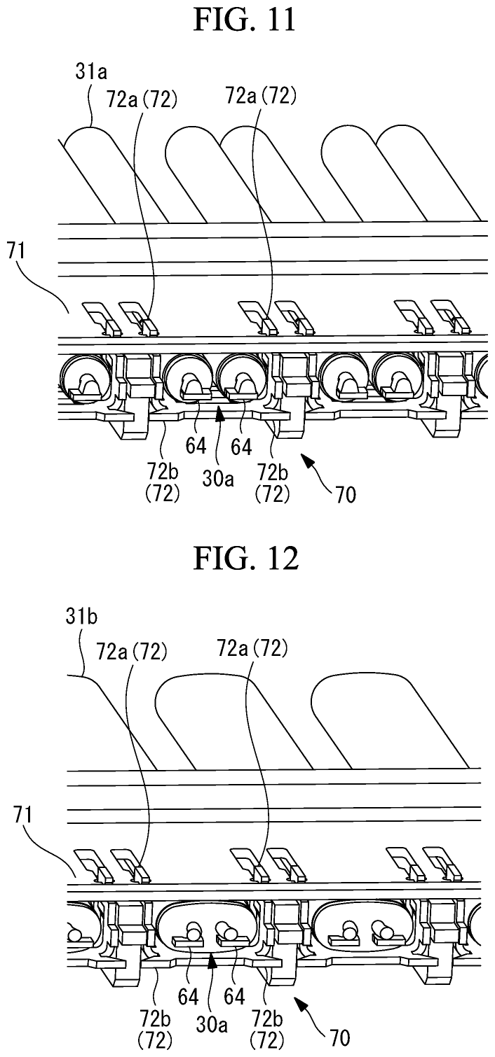

As illustrated in FIG. 11, the shell cover 71 is attached to the upper part of the shield terminals 72 so as to cover the open face of the shield parts 72a of the shield terminals 72. The shell cover 71 is a metal thin plate and forms the shield member 70 together with the shield parts 72a.

In other words, the shield member 70 has the shell cover 71 and the shield parts 72a and covers the circumference of respective differential pairs 30a.

The plurality of differential pairs 30a are arranged in parallel in a predetermined direction, and the plurality of shield terminals 72 are arranged in parallel in accordance with the parallel direction. In the present embodiment, the number of differential pairs 30a and the number of shield terminals 72 are the same.

As illustrated in FIG. 9, the shell cover 71 is integrally formed across the width direction of the cable connector 10B (the parallel direction of the shield terminals 72) and formed to cover the open faces of all the shield parts 72a at once.

To summarize the above, one differential pair 30a is covered with one shell cover 71 and one shield terminal 72 (shield part 72a), and all the differential pairs 30a are covered with one shell cover 71 and the shield terminals 72 (shield parts 72a), where the number of shield terminals 72 is the same as that of the differential pairs 30a. Further, three sides including a side in the parallel direction of the differential pairs 30a are covered with the shield terminal 72 (shield part 72a), and the remaining one side is covered with the shell cover 71. Accordingly, since proximate differential pairs 30a are separated from each other by the shield member 70, crosstalk that may occur between the proximate differential pairs 30a can be reduced.

In the present embodiment, the following advantageous effects are achieved.

According to the cable connector 10B, a part near the end of the differential pair 30a on the SMT connector 52 side (a part near a portion where the conducting wire 35 is exposed) can be covered with the shield member 70. Accordingly, even when the braided wires 33 as a shield layer of the coaxial cable 31a is absent, crosstalk that may occur between proximate differential pairs 30a can be reduced by the shield member 70.

Further, the shield member 70 has the shell cover 71 and the shield terminals 72. Thus, by installing the differential pairs 30a to the shield terminals 72 (shield parts 72a) from the opened one side of the shield terminals 72 (shield parts 72a) and then covering the opened one side with the shell cover 71, it is possible to easily configure a form in which the circumference of the differential pair 30a is covered.

Further, since the shell cover 71 is integrally formed in the parallel direction with respect to the shield terminals 72, it is possible to cover the open faces of all the shield terminals 72 with the single shell cover 71 at once. This can improve ease of assembly.

Note that, although the differential pair 30a is formed of two coaxial cables 31a in the above description, the differential pair 30b may be formed of a twinax cable (cable) 31b in which two conducting wires 35 run in one cable, as illustrated in FIG. 12.

In such a case, one twinax cable 31b will be covered with one shell cover 71 and one shield terminal 72 (shield part 72a), and all the twinax cables 31b will be covered with one shell cover 71 and the shield terminals 72 (shield parts 72a), where the number of shield terminals 72 is the same as that of the twinax cables 31b.

### Third Embodiment

The cable connector and the cable connector assembly according to a third embodiment of the present invention will be described below with reference to the drawings. Note that the present embodiment differs from the first embodiment and the second embodiment in the form of the shield member or the connection position of the cable connector. Thus, in the following description, the same features as those in the first embodiment and the second embodiment will be labeled with the same references to omit the description thereof, and different features will be described.

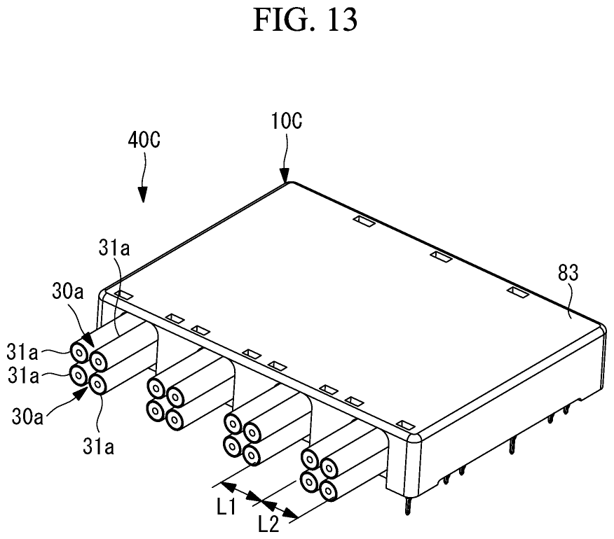

As illustrated in FIG. 13, a plurality of coaxial cables 31a and a cable connector 10C are connected to each other to form a cable connector assembly 40C.

The cable connector 10C is a so-called press-fit type connector and is directly mounted when a press-fit pin is pressed into the integrated circuit 50 such as an ASIC. This causes the integrated circuit 50 and the coaxial cables 31a to be electrically connected via the cable connector 10C. That is, the integrated circuit 50 and the cable connector assembly 40C are electrically connected to each other.

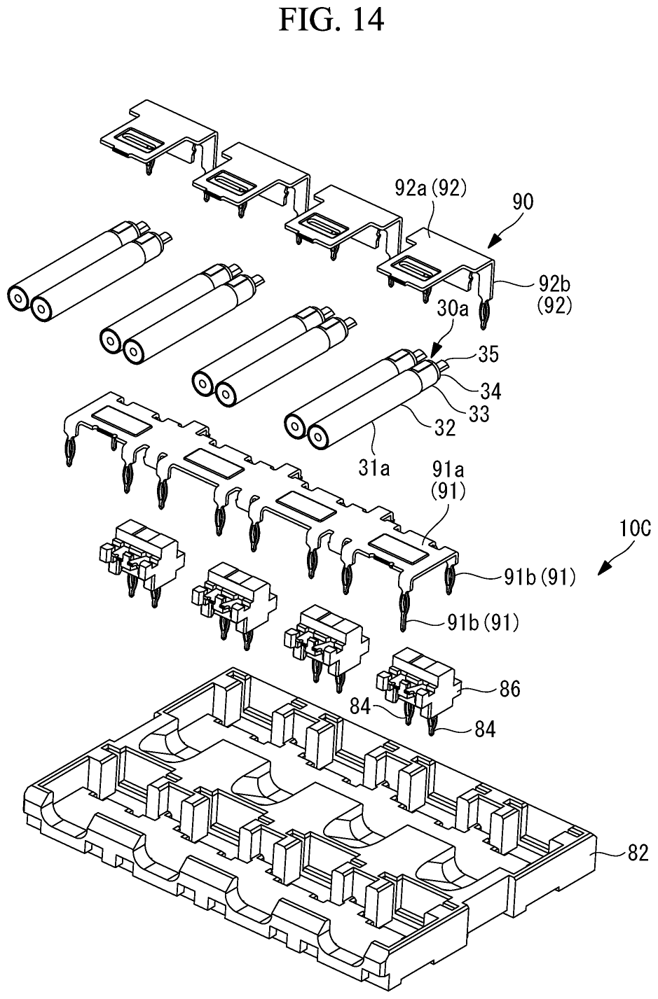

As illustrated in FIG. 14, the cable connector 10C has a resin housing 82, resin terminal holding members 86 attached from above the housing 82, a metal underside shield member 91 attached from above the housing 82, and metal upper side shield members 92 attached from above the underside shield member 91 in a form of interposing the coaxial cable 31a. Further, the cable connector 10C further has a plurality of signal terminals 84 held by the terminal holding members 86. A plurality of coaxial cables 31a are drawn from the housing 82.

As illustrated in FIG. 13, two coaxial cables 31a form one set of the differential pair 30a. Further, a plurality of differential pairs 30a are arranged in parallel and spaced apart from each other by a predetermined interval (L1 in FIG. 13) in a predetermined direction (the lateral direction in FIG. 13). The term “predetermined interval” as used herein is longer than or equal to a dimension (L2 in FIG. 13) in a predetermined direction of the differential pair 30a, for example. With the differential pairs 30a being spaced apart from each other, crosstalk between the differential pairs 30a proximate (adjacent) in a predetermined direction can be reduced.

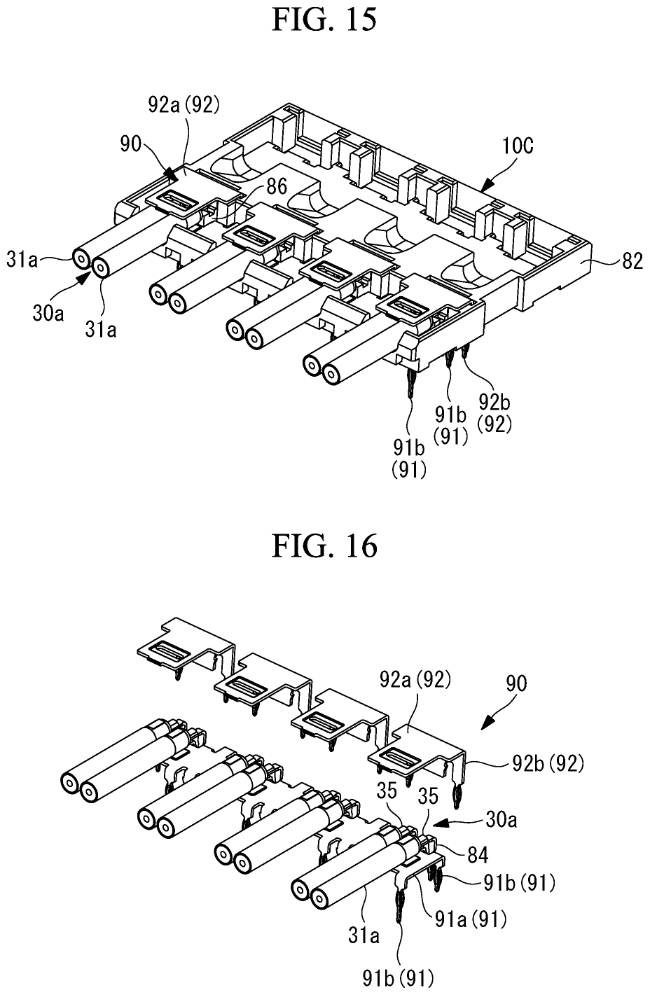

As illustrated in FIG. 15 and FIG. 16, the underside shield member 91, the signal terminals 84, and the upper side shield members 92 are arranged on the tip side (the integrated circuit 50 side) of the coaxial cables 31a.

As illustrated in FIG. 16, each signal terminal 84 is connected to the conducting wire 35 of the coaxial cable 31a in a one-to-one manner. The signal terminal 84 is electrically connected to a signal line of the integrated circuit 50.

Note that illustration of the housing 62 and the terminal holding member 66 is omitted in FIG. 16 for the sake of illustration. Further, the upper side shield member 92 is in a state of being spaced apart from the coaxial cable 31a.

The upper side shield member 92 has a planner upper side shield part 92a and a pin-like ground terminal part 92b protruding downward and has at least two functions.

First function is a function as a grounding terminal. The ground terminal part 92b integrally formed with the upper side shield part 92a to be in contact with the coaxial cable 31a is electrically connected to the ground on the integrated circuit 50 side. Accordingly, the ground terminal part 92b functions as a grounding terminal.

The second function is a function as a component of the shield member 90. The upper side shield part 92a of the upper side shield member 92 is installed for each differential pair 30a (two coaxial cables 31a) and covers the upper side of the differential pair 30a (see FIG. 15).

The underside shield member 91 has a planner underside shield part 91a and a pin-like ground terminal part 91b protruding downward and has at least two functions.

First function is a function as a grounding terminal. The ground terminal part 91b integrally formed with the underside shield part 91a to be in contact with the coaxial cable 31a is electrically connected to the ground on the integrated circuit 50 side. Accordingly, the ground terminal part 91b functions as a grounding terminal.

The second function is a function as a component of the shield member 90. The underside shield part 91a of the underside shield member 91 is integrally formed over the parallel direction of the differential pair 30a (two coaxial cables 31a) and configured to cover the underside of the differential pair 30a at once.

To summarize the above, the upper side and the underside of one differential pair 30a are covered with one underside shield member 91 (underside shield part 91a) and one upper side shield member 92 (upper side shield part 92a), and all the differential pairs 30a are covered with one underside shield member 91 and the upper side shield members 92, where the number of upper side shield members 92 is the same as that of the differential pairs 30a. Accordingly, even when one differential pair 30a and another differential pair 30a are installed in close proximity in the vertical direction, since differential pairs 30a are separated from each other by the shield member 90, crosstalk that may occur between the proximate differential pairs 30a can be reduced.

Note that, in the parallel direction of the differential pairs 30a, respective differential pairs 30a are physically separated from each other to reduce crosstalk, as described above.

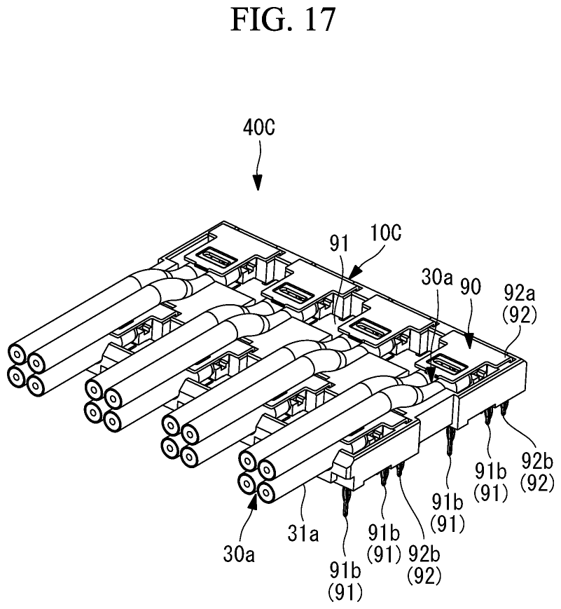

As illustrated in FIG. 17, in the cable connector assembly 40C, two coaxial cables 31a forming the differential pair 30a are stacked in two layers. In FIG. 17, the shield member 90 for the differential pair 30a formed of the coaxial cables 31a in the upper layer is provided on the tip side from and at the same height as the coaxial cables 31a in the lower layer. In this state, a cover 83 is fit into from the above side to configure a state illustrated in FIG. 13.

In the present embodiment, the following advantageous effects are achieved.

According to the cable connector 10C, a part near the end of the differential pair 30a on the integrated circuit 50 side (a part near a portion where the conducting wire 35 is exposed) can be covered with the shield member 90 from the upper and under sides. Accordingly, even when the braided wires 33 as a shield layer of the coaxial cable 31a are absent, crosstalk that may occur between vertically proximate differential pairs 30a can be reduced by the shield member 90.

Further, since the underside shield member 91 is integrally formed in the parallel direction of the differential pairs 30a, it is possible to cover the undersides of all the differential pairs 30a with the underside shield member 91 at once. This can improve ease of assembly.

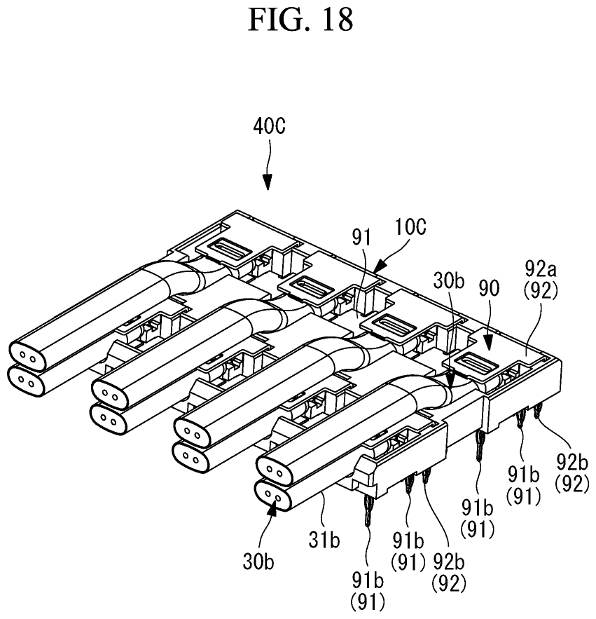

Note that, although the differential pair 30a is formed of two coaxial cables 31a in the above description, the differential pair 30b may be formed of a twinax cable (cable) 31b in which two conducting wires 35 run in one cable, as illustrated in FIG. 18.

### REFERENCE SIGNS LIST

10A, 10B, 10C cable connector
12 housing
20 shield member
21 underside shield member (first shield member)
22 U-shaped shield member (second shield member)
28 cage
30a, 30b differential pair
31a coaxial cable (cable)
31b twinax cable (cable)
32 outer sheath
33 braided wires
34 insulator
35 conducting wire
40A, 40B, 40C cable connector assembly
50 integrated circuit (electronic device)
52 SMT connector (electronic device)
62 housing
64 signal terminal
66 terminal holding member
70 shield member
71 shell cover (first shield member)
72 shield terminal
72a shield part (second shield member)
72b ground terminal part
82 housing
83 cover
84 signal terminal
86 terminal holding member
90 shield member
91 underside shield member
91a underside shield part
91b ground terminal
92 upper side shield member
92a upper side shield part
92b ground terminal part

1. A cable connector for electrically connecting one or more cables to an electronic device, the cable connector comprising:
a metal shield member configured to cover a circumference of a part near an end of a differential pair on the electronic device side, the differential pair being formed of the one or more cables.

2. The cable connector according to claim 1, wherein the shield member has a first shield member configured to cover one side of the circumference of the differential pair and at least one second shield member configured to cover all other sides of the circumference of the differential pair.

3. The cable connector according to claim 2,
wherein a plurality of second shield members are arranged in parallel in a predetermined direction, and
wherein the first shield member is integrally formed in the parallel direction with respect to the plurality of second shield members.

4. A cable connector for electrically connecting one or more cables to an electronic device, the cable connector comprising
a metal shield member configured to cover an upper side and/or an underside of a part near an end of each of a plurality of differential pairs formed of the one or more cables and arranged in parallel at a predetermined interval in a predetermined direction, and the end being on the electronic device side,
wherein a dimension of the predetermined interval is greater than or equal to a dimension of each of the differential pairs in the predetermined direction.

5. The cable connector according to claim 4 comprising the shield member configured to cover another set of the plurality of differential pairs stacked above and/or below the plurality of differential pairs.

6. The cable connector according to claim 1, wherein the shield member covers the differential pairs each formed of two cables.

7. The cable connector according to claim 1, wherein the shield member covers the differential pairs each formed of one cable.

8. A cable connector assembly comprising:
the cable connector according to claim 1; and
the one or more cables.

9. The cable connector according to claim 4, wherein the shield member covers the differential pairs each formed of two cables.

10. The cable connector according to claim 4, wherein the shield member covers the differential pairs each formed of one cable.

11. A cable connector assembly comprising:
the cable connector according to claim 4; and
the one or more cables.
